(19) United States
(12) Patent Application Publication
(10) Pub. No.: US 2025/0054321 A1
(43) Pub. Date: Feb. 13, 2025

(54) Systems and Methods for Processing Images to Detect Text

(71) Applicant: Eaigle Inc., Markham (CA)

(72) Inventors: Mahdi MARSOUSI, Maple (CA); Amir HOSSEIN, North York (CA); Bharath SEKAR, Markham (CA); Akshaya MISHRA, Whitby (CA)

(73) Assignee: Eaigle Inc., Markham (CA)

(21) Appl. No.: 18/734,938

(22) Filed: Jun. 5, 2024

Related U.S. Application Data
(60) Provisional application No. 63/531,553, filed on Aug. 8, 2023.

(51) Int. Cl. G06V 20/62; G06V 10/26

(52) U.S. Cl. CPC G06V 20/62; G06V 10/26

(57) ABSTRACT

The disclosure relates to a system, method, and computer readable medium for processing images to detect text. Illustratively, the method includes subdividing received images with a partitioner to generate one or more sub-images of respective objects in the received images, and subdividing the generated one or more sub-images with a text detector to generate, for each sub-image, one or more text box sub-images. The method includes processing the generated text box sub-images with a text box simplifier to generate simplified text box images having less information than the text box sub-images, and determining text from the simplified text box images.

### CROSS REFERENCE TO RELATED APPLICATIONS

This application claims priority to U.S. Provisional Patent Application No. 63/531,553 filed on Aug. 8, 2023, the contents of which are incorporated herein by reference in their entirety.

### TECHNICAL FIELD

This application is directed towards processing images to detect text, and more particularly to computer vision and artificial intelligence approaches to detecting text in images.

### BACKGROUND

Automated detection of text in images, referred to as optical character recognition (OCR), has found applications in various scenarios, including automatic license plate recognition (ALPR), electronic toll collections, smart parking management, and automated yard management systems.

OCR applications can suffer from a lack of accuracy, onerous implementation requirements, and difficulty in maintenance and upgrading. In respect of accuracy, OCR applications can have significant accuracy deterioration when in other than ideal circumstances. For example, images of real-world instances which include rain, snow, particles, poor lighting, complex backgrounds, or crowded and high-throughput scenarios, etc., can cause an undesirable drop in accuracy. In respect of implementation, certain OCR applications require specialized cameras (e.g., as have been employed for license plate reading in constrained settings), such as cameras that use infrared flashes or illumination, or the OCR models can require specialized or expensive hardware (e.g., dedicating server capacity that can be expensive) in the event that the implementation is on premises, or expensive to operate with cloud computing resources. In respect of maintenance, some existing OCR approaches have a single model that performs all aspects of OCR, making updating or maintaining the OCR difficult.

In addition, even when existing OCR systems correctly recognize individual characters, it is difficult to cluster recognized characters to make use of the recognized characters. For example, clustering the recognized characters into respective categories, such as license plate, truck numbers, trailer number, logos, company name, and other categories, is difficult. This difficulty is particularly acute in high throughput applications.

Improvement is desirable.

### SUMMARY

In an aspect, a system for processing images to detect text is disclosed. The system includes at least one imaging device, a processor, and a memory in communication with the imaging device, and the processor. The memory stores computer executable instructions that cause the processor to subdivide images received from the imaging device with a partitioner to generate one or more sub-images of respective objects in the received images, and subdivide the generated one or more sub-images with a text detector to generate, for each sub-image, one or more text box sub-images. The instructions cause the processor to process the generated text box sub-images with a text box simplifier to generate simplified text box images having less information than the text box sub-images, and determine text from the simplified text box images.

In example embodiments, in order to determine text from the simplified text box images, the instructions cause the processor to, with a text recognizer, localize the simplified text box images within the respective sub-image, and classify the simplified text box image into one of a plurality of pre-determined categories.

In example embodiments, the images comprise a plurality of objects, or the images comprise a plurality of images of an object.

In example embodiments, the simplified text box image is a binary image. In example embodiments, the instructions cause the processor, with the partitioner, assign a class to each detected object. Determining text from the simplified text box images can be based on the class assigned the respective detected object.

In example embodiments, the instructions cause the processor update one of the partitioner, the text detector, or the text box simplifier and process a subsequent image to detect text based on the updated one of the partitioner, the text detector, or the text box simplifier.

In example embodiments, to determine text from the simplified text box images, the instructions cause the processor to process the generated simplified text box images with a text recognizer to generate predictions of the text in the simplified text box images. The instructions cause the processor to process the predictions with a temporal smoother to leverage temporal relationships between characters to which the prediction relates to in order to determine the text. In example embodiments, the instructions can cause the processor to (1) retrieve respective one or more sub-images associated with the simplified text box images and their corresponding categorizations, and (2) process the predictions and the retrieved respective one or more sub-images and corresponding categorizations with the temporal smoother to leverage temporal and spatial relationships between characters to which the prediction relates to in order to determine the text. In example embodiments, the temporal smoother employs a Kalman filter and temporal smoothing algorithm to process the predictions to remove low-confidence predictions.

In example embodiments, to determine text from the simplified text box images, the instructions can cause the processor to process the generated simplified text box images with a text recognizer to generate predictions of the text in the simplified text box images. The text recognizer can generate a plurality of predictions for text in each of the simplified text box images. The text recognizer can be configured with a multi-category loss function based on the plurality of predictions. The text recognizer can be configured to perform more than one prediction of text in the generated simplified text box images to perform multi-pass hierarchical classification.

In another aspect, a method for processing images to detect text is disclosed. The method includes subdividing received images with a partitioner to generate one or more sub-images of respective objects in the received images, and subdividing the generated one or more sub-images with a text detector to generate, for each sub-image, one or more text box sub-images. The method includes processing the generated text box sub-images with a text box simplifier to generate simplified text box images having less information than the text box sub-images, and determining text from the simplified text box images.

Determining text from the simplified text box images can include, with a text recognizer, localizing the simplified text box images within the respective sub-image and classifying the simplified text box image into one of a plurality of pre-determined categories.

The simplified text box images can be binary images.

The method can include, with the partitioner, assigning a class to each detected object. Determining text from the simplified text box images can be based on the class assigned the respective detected object.

The method can include updating one of the partitioner, the text detector, or the text box simplifier, and processing a subsequent image to detect text based on the updated one of the partitioner, the text detector, or the text box simplifier.

Determining text from the simplified text box images can include processing the generated simplified text box images with a text recognizer to generate predictions of the text in the simplified text box images, and processing the predictions with a temporal smoother to leverage temporal relationships between characters to which the prediction relates to in order to determine the text.

Determining text from the simplified text box images can include processing the generated simplified text box images with a text recognizer to generate predictions of the text in the simplified text box images, with the text recognizer generating a plurality of predictions for text in each of the simplified text box images.

In another aspect, a non-transitory computer readable medium (CRM for processing images to detect text and comprising computer executable instructions. The computer executable instructions, when executed by a processor, cause the processor to subdivide images received from the imaging device with a partitioner to generate one or more sub-images of respective objects in the received images, and subdivide the generated one or more sub-images with a text detector to generate, for each sub-image, one or more text box sub-images. The instructions cause the processor to process the generated text box sub-images with a text box simplifier to generate simplified text box images having less information than the text box sub-images, and determine text from the simplified text box images.

### BRIEF DESCRIPTION OF THE DRAWINGS

Embodiments will now be described with reference to the appended drawings wherein:

FIG. 1 is a schematic diagram of a system for processing images to determine text.

FIG. 2A is a flow diagram of an example aspect of the system for processing images to determine text.

FIG. 2B is a block diagram of an example of the aspect of FIG. 2A.

FIG. 3 is a flow diagram of another aspect of the system for processing images to determine text.

FIG. 4A is a flow diagram of an example text box segmentation of the system for processing images to determine text.

FIG. 4B is a block diagram of an example of the aspect of FIG. 4A.

FIGS. 5A and 5B are together a block diagram of an example workflow for processing images to determine text.

FIG. 6 is a block diagram of an aspect of the example workflow for processing images to determine text.

FIG. 7 is a block diagram of another aspect of the example workflow for processing images to determine text.

FIG. 8 is flow diagram for a method for processing images to determine text.

FIG. 9 is a block diagram of an example device for processing images to detect text.

### DETAILED DESCRIPTION

As used herein, the term “retrieve” can denote a one of actively seeking the information (e.g., requesting information and retrieving information from a subsequent response), receiving information passively (e.g., having information pushed without any request), or combinations or variations of the above.

Throughout the present description, various terms should be interpreted as follows, unless the context indicates otherwise: The term “or” as used throughout, should be understood as inclusive, akin to “and/or.” Singular articles and pronouns encompass their plural forms, and vice versa. Similarly, gendered pronouns include their counterparts, thus the use of pronouns should not imply a limitation of anything described herein to a specific gender. The term “exemplary” should be understood to mean “illustrative” or “exemplifying,” and not necessarily “preferred” over other embodiments. Further definitions for terms may be provided herein, applicable to both prior and subsequent instances of those terms, as discernible from a reading of the present description.

Any module, unit, component, server, computer, terminal, engine, or device exemplified herein that executes instructions may include or have access to computer-readable media, such as storage media, computer storage media, or data storage devices (both removable and non-removable), such as magnetic disks, optical disks, or tape. Computer storage media may comprise volatile and non-volatile, removable, and non-removable media, implemented through any method or technology for information storage, including computer-readable instructions, data structures, program modules, or other data. Additionally, unless the context clearly suggests otherwise, any processor or controller described herein may be implemented as a single processor or a plurality of processors.

This application is directed towards general character recognition (GCR) systems, which include the use of computer vision and/or machine learning technologies to process image(s) to determine text therein. The application will make reference to GCR being applied to the detect text in the example setting of logistics and trucking. It is understood that the examples relating to logistics and trucking are just that, examples, and that the application is not limited to these example settings.

Existing optical character recognition (OCR) systems can be expensive or cumbersome to implement. For example, specialized cameras have been employed for license plate reading in constrained settings, utilizing OCR to interpret the text. However, these configurations demand specific camera positioning and are unsuitable for reading other essential texts like trucks and trailer numbers, company logos, and websites. Advancements in deep learning technology have failed to improve OCR as desired, including, for example, OCR's ability to detect and determine vertically or angularly written texts, particularly in crowded and high-throughput multi-vehicle scenarios.

To address challenges with existing OCR, the present disclosure adopts a modular deep learning approach to accurately read texts simultaneously from multiple vehicles in challenging high throughput scenarios. This approach may result in improved accuracy or efficiency in crowded and fast-paced environments.

This disclosure is at least in part directed towards GCR that leverages transformers within the deep learning framework to improve image-based object detection, instance segmentation, semantic segmentation, and image classification. The disclosed GCR systems can include techniques like MaskRCNN, Yolo, DetR, and panoptic segmentation to aid object detection and instance segmentation.

In an aspect of the disclosure, the GCR includes a modular system comprising at least three components, or four components, coupled with a temporal smoothing technique. Each of the four components can be components of a deep learning algorithm. The disclosed GCR can be integrated in an automatic vehicle access control system and can be trained to automatically read various types of texts present or related to vehicle(s), including license plate numbers, truck numbers, trailer numbers, logos, and other inscriptions.

Firstly, a deep learning model is trained to detect vehicles within an image frame. Subsequently, in the second stage, another deep learning model is deployed to estimate text boxes using cropped images obtained from the previous detection step. A third deep learning model is trained to perform binarization on the detected text box, distinguishing text pixels as white and background pixels as black. A fourth deep learning model is trained to detect and recognize each character within the binarized text box. The recognized texts can be monitored over more than one image and the low confidence texts are filtered out using temporal tracking and smoothing.

Each of the models for the different stages can be individually updated depending on the objects being detected, or other contextual information. For example, the first stage can include a deep learning model that is trained to detect people, or aircraft, or retail goods, etc.

In testing, a system configured with the modular approach above enabled a system to adeptly read texts on vehicles regardless of their orientation, size, and position with increased accuracy. With its capacity to overcome the challenges posed by unconventional text orientations, the disclosed GCR.

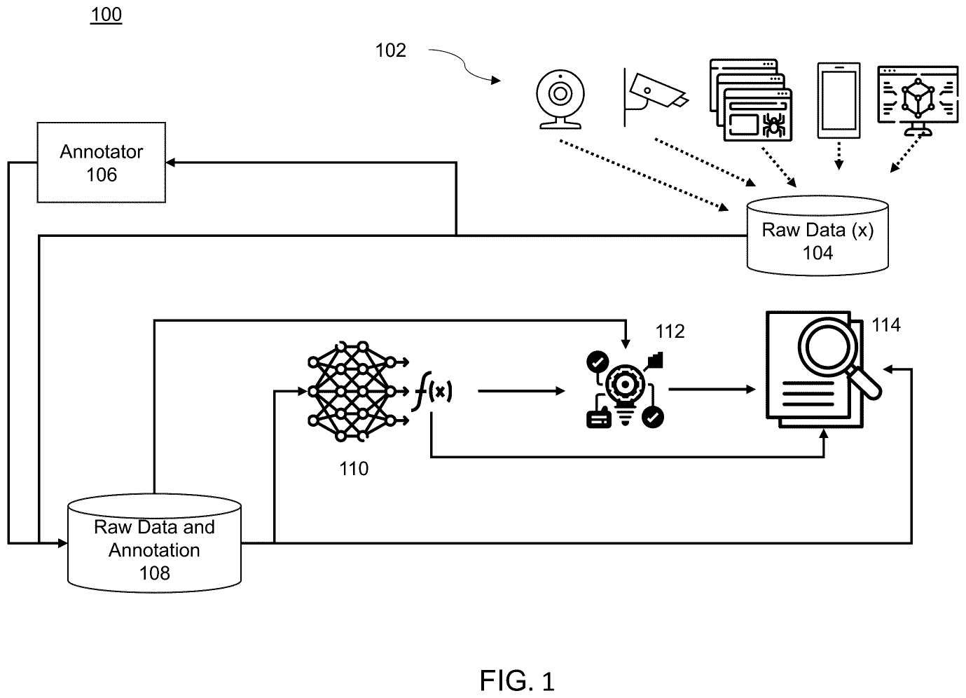

Referring now to FIG. 1, is a schematic diagram of a system for processing images to determine text is shown. The shown system 100 includes, illustratively, a plurality of data sources 102, a raw datastore 104, an annotator 106, a datastore 108, a text recognition model 110, an optimizer 112, and an evaluator 114.

The text recognition model 110 is, for example, a neural network, which receives an input vector or tensor and converts it to categorical or continuous output. Optimizer 112 is an optimization function, for example, ADAM or stochastic gradient descent function, which compares the output of model 110 with a ground truth, and adjust the weights of model 110 until model 110 output is near equal to ground truth. The evaluator 114 is an evaluation unit that compares the output of model 110 with some external ground truth (e.g., test datasets) to make sure model 110 is not memorizing the training datasets.

The plurality of data sources 102 can include devices that generate data used to determine text from images. The data can be training data (e.g., an image provided to be annotated for training), images where text needs to be detected, or non-image data which can facilitate training or detecting text. For example, as shown, the data can include data source 102 can be a simulation that generates training data, or a public domain that includes a plurality of data which may or may not include imaging data, or a camera that generates images, such as a camera having a fixed or varying field of view, such as a camera of a mobile device, a webcam, or a security camera.

It is understood that while a plurality of data sources 102 are shown, implementations with a single data source are contemplated. Similarly, while FIG. 1 shows various different data sources 102, this disclosure contemplates embodiments that include various combinations of data sources, including implementations where only a single data source 102 type is used (e.g., a single type of security camera), where different data sources are used (e.g., data from a simulation and a cell phone), in different combinations.

The data from the plurality of data sources 102 can be provided to the raw datastore 104. The datastore 104, while shown as a single data store, can be multiple hardware devices acting in coordination. The datastore 104 can at least include cloud-based storage, where hardware on a premises coordinates with hardware offered by a third party (e.g., Amazon's AWS) for storage and other purposes.

Data stored in the datastore 104 can be stored in a variety of formats, and different divisions of the datastore 104 can be used to store data in different formats. For example, raw data from the sources 102 provided to the datastore 104 can be stored in a first division, raw data processed into a desired format can be stored in another division, etc. The data in the datastore 104 can be stored based on a user-defined JSON file configuration that the sources 102 adhere to.

Data in the datastore 104 can be provided to an annotator 106. The annotator 106 can be an automated annotator, an application that receives input to annotate data (e.g., similar to a CAPTCHA system for images), etc. For example, the annotator 106 can annotate images with provided labels that are also stored separately in the raw data store 104 (e.g., a label is retrieved from one source 102, and the related images is retried from a second source 102).

The datastore 108 can be used to store raw and annotated data. While FIG. 1 shows the datastore 108 and datastore 104 as separate data stores, it is understood that the datastores 108 and 104 can be different divisions of a single data store (e.g., different aspects of a cloud based storage system).

The datastores 104 and/or 108 can also store the text recognition model 110, optimizer 112, and/or an evaluator 114, or a separate datastore or aspect of the datastores 104 and/or 108 can be used for these components.

The text recognition model 110 can be used to generate a prediction of text based on received images. The images can be received from the datastore 108, or the datastore 104. For example, during a training phase, the text recognition model 110 can receive data from the datastore 108, to ensure that all images processed have a corresponding annotation, while during an operational phase, the text recognition model 110 can receive images directly from the raw datastore 104.

The text recognition model 110 can comprise a plurality of modular components used for different stages of text detection. Each of the components can be stand alone, in that they can be updated without requiring action to the remaining components (or requiring minimal changes to the other components). For example, an object detector can be updated to detect a greater class of objects without impacting the text related components.

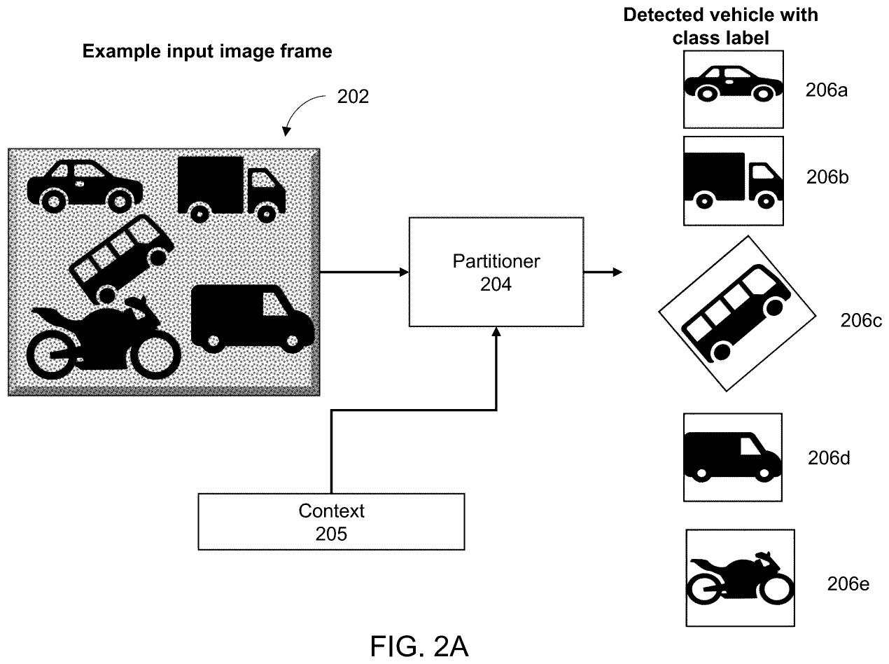

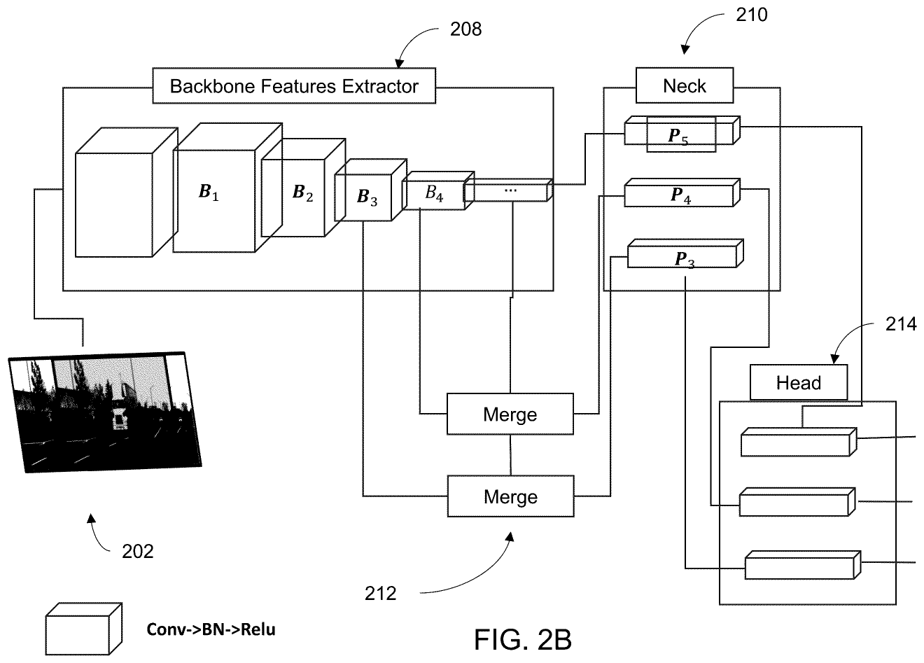

Referring now to FIG. 2A, a flow diagram of an object detection aspect of the text recognition model 110 is shown. In FIG. 2A, the image 202 is provided to a partitioner 204, which partitions the image 202 into subset image(s) 206 of detected objects. The partitioner 204 can be trained to localize and classify object(s) of interest (in the shown example, vehicles) present in the image 202. For clarity, the partitioner 204 can be trained to detect one, or many different objects. In the shown example, the partitioner 204 has been trained to detect the presence of and classify vehicles into the following classes: car, truck, bus, motorcycle, van, and others, resulting in the illustrated five (5) generated subset image(s) 206a to 206e.

The partitioner 204 can be a deep learning-based component, such as a customized YoloV6 model. For example, the partitioner 204 in the shown embodiment is trained to localize vehicle bounding boxes and to assign a class to each detected vehicle. The partitioner 204 can be trained in a variety of manners and incorporate a variety of subcomponents. For example, the partitioner 204 can be trained to detect and classify any number of objects and can incorporate other existing DL model architectures into the current partitioner 204. The partitioner 204 can also be used to retrofit or maintain existing models, or to combine existing models to provide a single component that localizes and classify object(s) of interest.

The partitioner 204 can be provided with context information, shown as context 205. The context 205 can include physical locations (e.g., Canada/USA, Provinces/States), temporal elements (e.g., time of day), and information about the environment or environment type, such as the weather (e.g., winter, raining, etc.) or other seasonal information, etc.

FIG. 2B is an illustration of an object detection aspect of a system for processing images. While the shown embodiment is adapted to detect vehicles, a person skilled in the art will appreciate that the shown aspect can be adapted to other than vehicles.

In FIG. 2B, the image 202, being an image of five vehicles, is provided to a backbone feature extractor 208 (alternatively referred to as a first aspect of the partitioner 204) of a partitioner 204. As indicated in the legend, the backbone feature extractor 208 can include a plurality of convolutional networks, applying batch normalization with rectified linear unit (ReLu) activation functions.

The backbone feature extractor 208 can be trained to identify one or more features in the image 202. A feature can include a vehicle hood, a road sign, or an unspecified feature determined by the training process, etc.

The features detected by the backbone feature extractor 208 can be provided to a feature combiner, shown as the neck 210. The neck 210 can receive individual features, as shown by the top convolutional network of neck 210 and can be configured to receive a combination of features from the backbone feature extractor 208, as shown by the features of the backbone feature extractor 208 processed with a merger 212. The use of the neck 210 in addition to the merger 212 can serve to focus different networks on different combinations of features.

The neck 210 can provide the combined features to a object detector, labelled as the head 214. The head 214 can, based on previous training on annotated images, determine a position, size, and class of the detected objects. The determined position can be a precise location of each vehicle in the image 202, specifying the coordinates or bounding box that encapsulates the vehicle's boundaries. The determined size can be determined by calculating the size of each detected vehicle, which can be represented by dimensions such as width, height, or area. The determined class can be one enumerated and trained for. For example, the head 214 can provide output indicative of the vehicle in the image 202 a specific class or category such as a car, truck, motorcycle, etc. Alternatively stated, the head 214 can project received features from the neck 210 into object detection space.

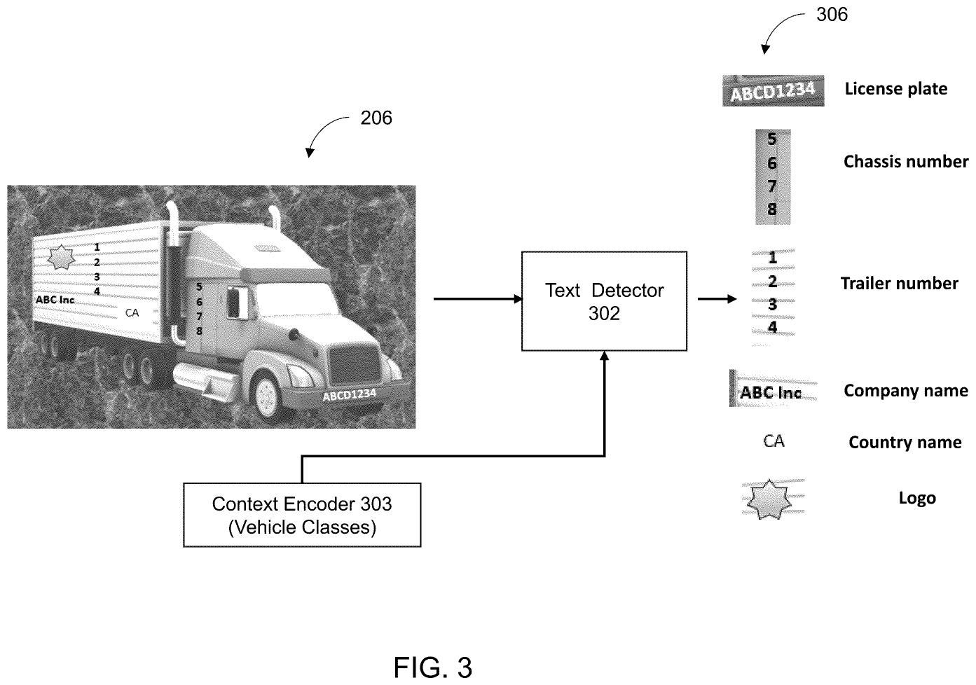

FIG. 3 shows a flow diagram of text detection aspect of the text recognition model 110. In FIG. 3, a sub-image 206 is provided to a text detector 302 which further partitions the sub-image 206 into text sub-image 306 (shown with a single label, for visual clarity).

As shown, the text detector 302 conducts an analysis on these detected vehicles. The main outputs generated by the text detector are text bounding boxes, or text sub-images 306, precisely identifying and outlining the boundaries of text regions within the sub-image 206. The text detector 302 can also assign a specific class or category to each text bounding box, characterizing the type or nature of the text present within that region. The class or category of the text bounding box can play a vital role in the overall text reader system, enabling accurate text segmentation and recognition, thus facilitating the system's ability to effectively extract and process text data from the objects even in high throughput scenarios.

The text detector 302 can be a context-aware DL-based oriented text detector. The text detector 302 can use a context encoder 303 and oriented bounding box to build a customized YoloV6 model trained to localize text bounding boxes (i.e., text sub-image 306) in any orientation and to assign a class to each detected text box. In an example in the transportation industry, the text detector 302 can be trained to classify text boxes into the following classes: license plate, truck number, container number, log, chassis, CA, US, Tel, VIN, WWW, CAP, EV. Similar to the partitioner 204, the text detector 302 can also be used to retrofit or maintain existing models, or to combine existing models to provide a single component that localizes and classify text box(es) of interest.

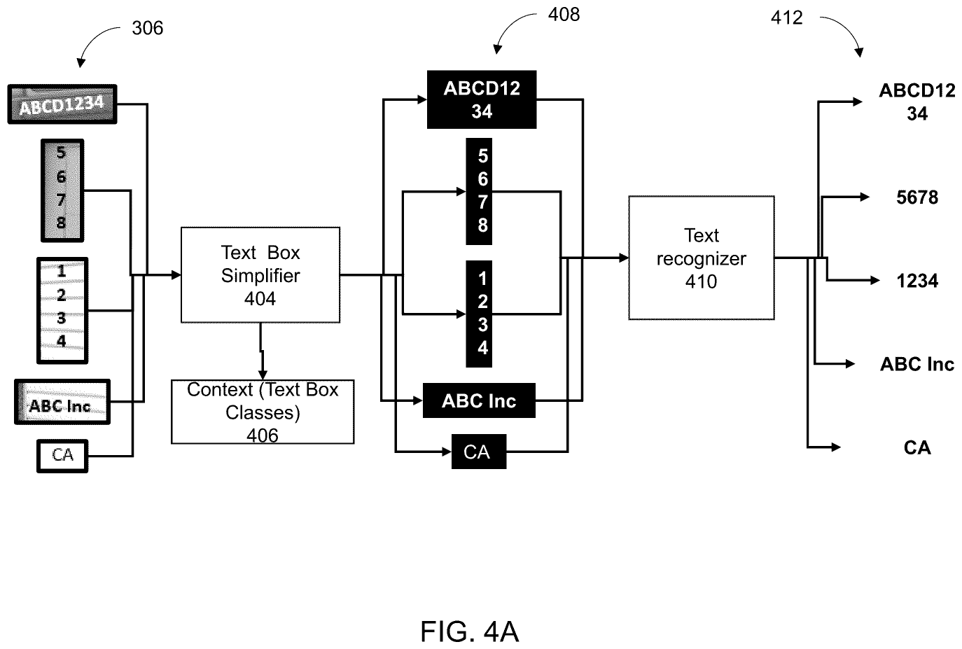

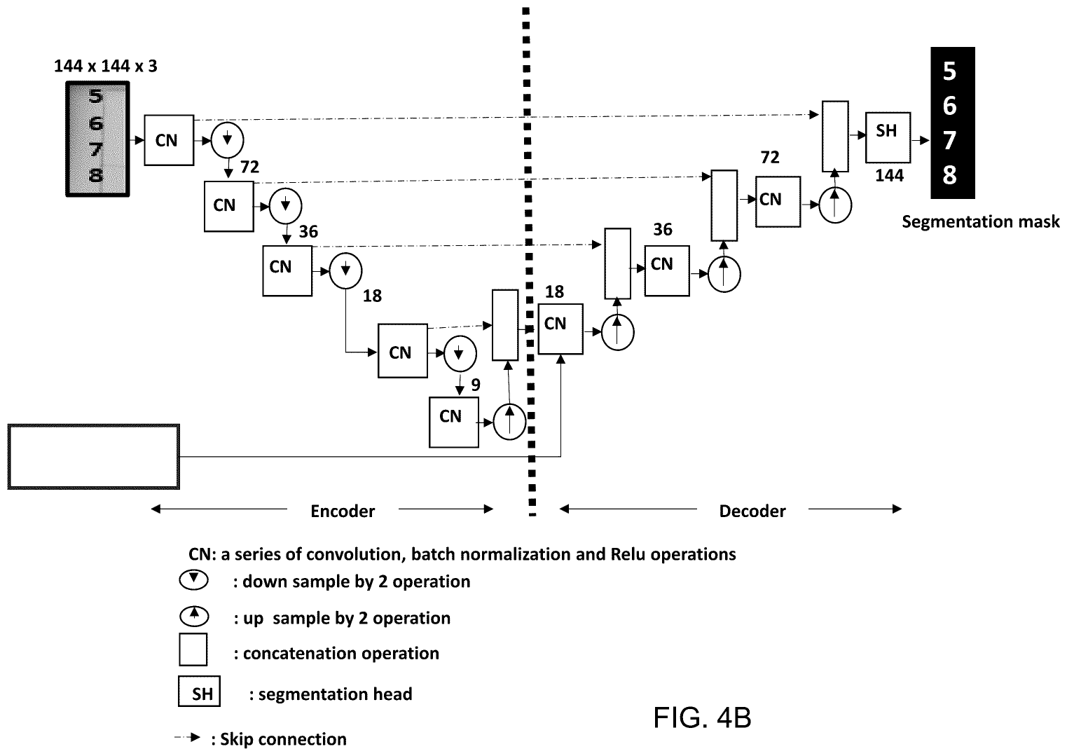

FIG. 4A is a flow diagram of a text box segmentation aspect of the system for processing images to determine text.

A text box simplifier 404 is used to process the text sub-images 306 and to generate simplified text sub-images 408. The simplified text sub-images 408 reduce the amount of information in the text sub-images 306 to reduce resources required for processing (data is easier to store, less data in the image 408), and to focus the text sub-images 306 on text features to a greater degree (e.g., subsequent processing does not need to understand the nuance introduced by the removed information). In the shown embodiment, the text box simplifier 404 generates simplified text sub-images 408 that are binary black and white representations of text in the text sub-images 306.

The text box simplifier 404 be a context-aware (e.g., based on the context module 406) deep learning technique and algorithm. For example, context can be incorporated into the text box simplifier 404 via U-Net architecture, a framework for semantic segmentation tasks. The text box simplifier 404 can include U-Net architecture specifically tailored for text segmentation.

Referring now to FIG. 4B, an example text box simplifier 404 is shown. The example text box simplifier 404 includes and encoder/decoder architecture, where the text sub-images 306 are projected into an embedding space and the decoder projects the embedding features into a segmentation space.

Referring again to FIG. 4A, a text recognizer 410 receives the simplified text sub-images 408, and generates a prediction 412 of the text therein. The text recognizer 410 can localize and classify each text character present in the simplified text sub-images 408 to generate the prediction 412.

The text recognizer 410 can employ advanced deep learning algorithms and techniques. For example, the text recognizer 410 can include Yolov6 components (Yolov6 is a convolutional neural network (CNN) architecture), or other CNNs. CNNs are well-suited for character recognition tasks due to their capacity to learn intricate patterns and features from images, thus effectively addressing variations in font styles, sizes, orientations, and potential noise and distortions. The text recognizer 410 can localize characters, extract features, classify extracted features, and generating a confidence score. Character localization can include the text recognizer 410 precisely localizing individual characters within the simplified text sub-images 408 and determining the exact starting and ending points of each character to ensure accurate character segmentation. Feature extraction can include the text recognizer 410 extracting relevant features from each localized character, capturing distinctive characteristics that facilitate differentiation between characters. Character classification can include the text recognizer 410 leveraging the extracted features to categorize each character into specific classes (e.g., letters, numbers, symbols, and other pertinent textual components). Confidence score generation can include the text recognizer 410 assigning a confidence score to each recognized character, indicating the level of certainty in its classification. Elevated confidence scores signify heightened reliability in character recognition.

Due to the existence of considerable similarities among various character pairs, such as (O, Q), (1, I), and (2, z), and even within groups like (O, Q, D, 0), accurately recognizing each character through a single-pass classifier proves challenging. To address this, a multi-category loss function and multi-pass hierarchical classification system is used to train the model 110, ensuring precise character recognition.

More particularly, the multi-pass hierarchical classification system can assign multiple labels to a single character. For example, when presented with an unknown character (O), during the initial pass, the system allocates several potential categories along with corresponding probability scores-potentially identifying the instance as (O, Q, 0, D). Throughout training, probability scores are statistically precomputed using training data (e.g., an extensive vehicle text corpus). Notably, in lieu of employing conventional categorical cross-entropy loss functions, a multi-label cross-entropy loss is employed to train the character recognition DL models. For example, labels of the multi-label cross-entry loss can be possible values of an unknown character such as a character which can be one of 2 or Z; or 1 or I; or 0 or O.

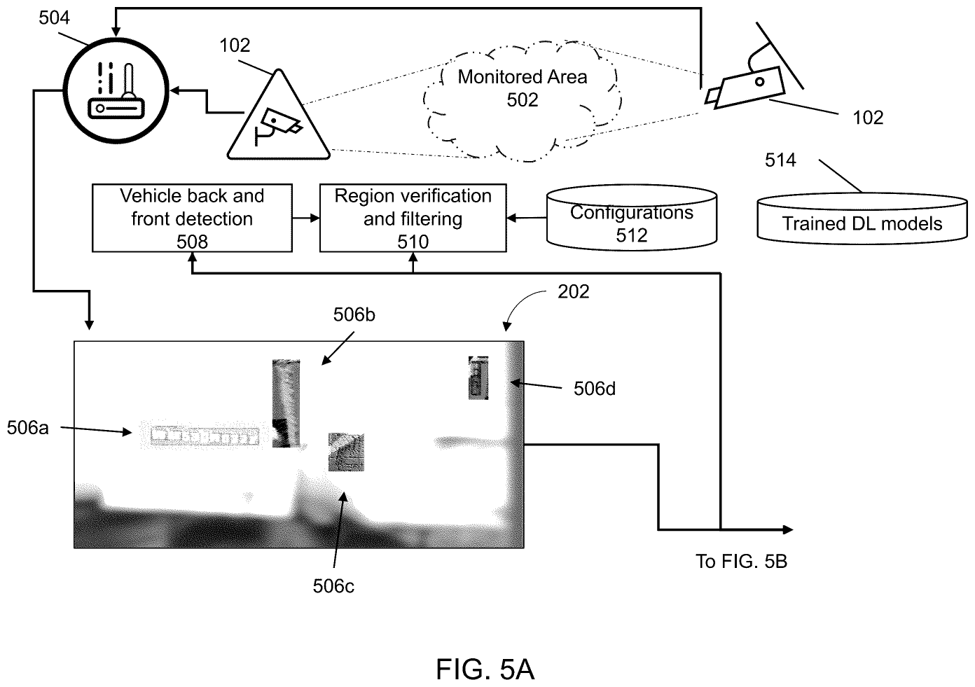

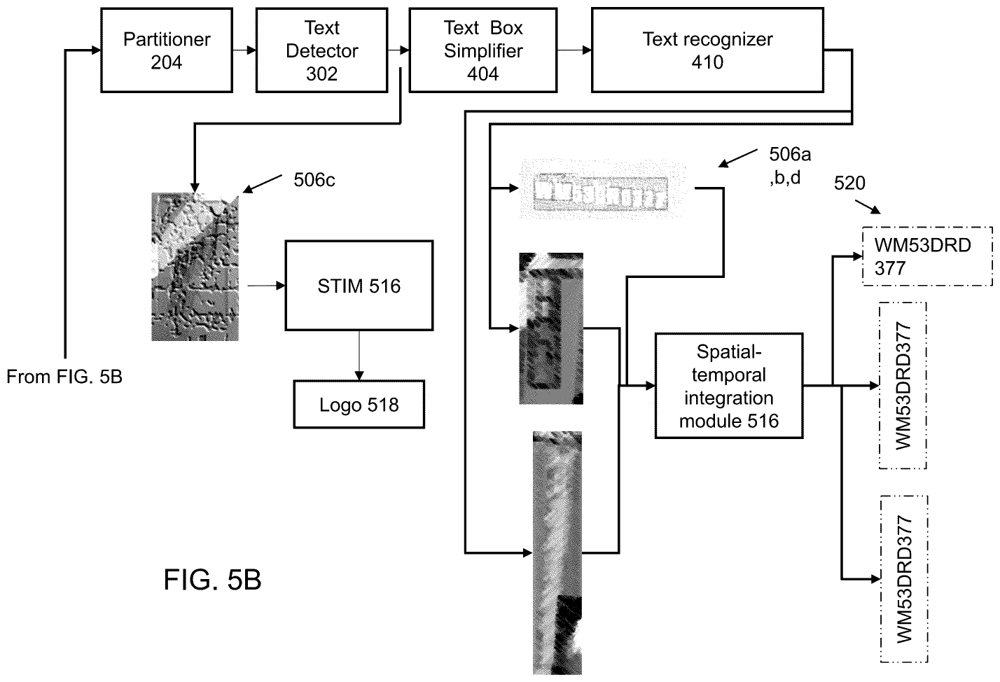

FIGS. 5A and 5B are together a block diagram of an example workflow for the training of processing images to determine text.

In FIG. 5A, image generating sources 102 are directed towards a monitored area 502. The image generating sources 102 provide images of the area 502 to a network device 504. Providing the images to the network device 504 can involve the use of various networking technologies, including wired or wireless technologies such as local area networks, etc.

Illustratively, the shown image 206 includes four features 506 for determination (shown as text features 506a, 506b, 506d, and logo feature 506d).

The training process can include an object edge detection module 508 (e.g., a detector trained to detect the front and back side of a vehicle), a region verification and filtering module 510, and a configuration datastore 512.

The region verification and filtering module 510 can be used to determine the presence of objects in an object in the monitored area. For example, the region verification and filtering module 510 can be trained to detect changes to the appearance of the monitored area 502 when empty.

The object edge detection module 508 can be used to detect the ends of an object within the images. For example, the ends can be a front and back of a vehicle. The edge of the object can be important because of the location of relevant text (e.g., a vehicle includes license plates at the front and back). The object edge detection module 508 can also be trained to detect other than edges, or to learn surfaces of an object where text is expected.

The configuration datastore 512 can include a plurality of configuration parameters such as images of the field of view of the image generating source 102 (which can be used for elimination purposes), information about the field of view of the different image sources 102 (e.g., camera 1 has a field of view that slightly overlaps camera 1), configurations about the size of the model being used, which iteration of which model is used (e.g., a new text detector is being tested), etc. The configuration parameters can configure what do with objects that are in a monitored area 502, but do not have useful surfaces as captured by the object edge detection module 508.

The results of the training process, trained text recognition models 110, or components thereof, can be stored in a trained model datastore 514.

Training of the text recognition model 110, where FIG. 5B shows the partitioner 204, the text detector 302, the text box simplifier 404, and the text recognizer 410 components and a temporal smoother (as discussed in greater detail below), can include the image 202 being provided to the partitioner 204 to generate the sub-images, the sub-images being provided to the text detector 302 to generate text box sub-images, and those images being provided to the text recognizer 410.

As shown in FIG. 5B, the text detector 302 can also be trained to detect logos or other symbol-based images that are not text, such as feature 506c. In the event that the text detector 302 determines the presence of these non-text features, or features which only partially incorporate text, that feature can be provided to a temporal smoothing filter module (STIM) 516. The STIM 516 can receive as input a plurality of images of the feature 506c (e.g., at different times, or from different views, if the sources 102 overlap, etc.), and determine the identify of the symbol 518 (e.g., a logo) or the text within the symbol 518 (e.g., in the event that the symbol is unknown, and not in the training data).

In at least some configurations, the text recognition model 110 can include a STIM 516 to determine text. STIM 516 can be helpful in high-throughput applications that face challenges such as self and external occlusions, viewpoint changes, lighting variations, and the presence of foreign objects. These challenges make text recognition from a single frame (image) lack desired robustness. To address these issues, the STIM 516 collects text recognition confidence from the text recognizer 410 for each frame, tracks the confidence scores over time (e.g., using Kalman filters), and employs smoothing filtering to retain high-confidence text recognition outputs and reject low-confidence ones.

The partitioner 204, the text detector 302, the text box simplifier 404, and the text recognizer 410 components and the STIM 516 can be continuously applied to every image generated a source(s) 102. For example, in the logistics industry, the model 110 can be applied for each image having a vehicle present to determine text, and thereafter execute necessary control actions based on the detected text. For example, automated entry/exit systems in logistics facilities, ports and terminals can be bolstered with automated text recognition.

In these configurations, as shown in FIG. 5B, various confidence scores from the text recognizer 410 are provided to (or retrieved from the text recognizer 410) the STIM 516 to determine a final prediction of the text characters. The STIM 516 assigns each text recognizer 410 recognized character to its corresponding text box and object (e.g., vehicle). In high-throughput scenarios, accurately associating each character with the correct text box and object can be challenging due to various factors such as occlusions, viewpoint changes, lighting variations, and the presence of foreign objects.

The STIM 516 can process the at least some of the simplified text sub-images 408 and the images 206, along with their corresponding class assignments, to leverage the information obtained from the partitioner 204, the text detector 302, the text box simplifier 404, and the text recognizer 410 components (hereinafter referred to in the alternative as the top-down components). The STIM 516 can use Kalman filtering and smoothing to analyze the spatial and temporal relationships between the recognized characters. By considering the sequence of frames over time, the STIM 516 effectively tracks the characters and associates them with the correct text boxes and objects.

The STIM 516, alternatively referred to as a bottom-up process, by leveraging the already provided information, can potentially achieve robust and accurate clustering of recognized characters into their respective categories (e.g., such as license plate numbers, trailer, container, chassis, USDOT, CA numbers, logos, and other inscriptions, logos, company names, and other textual information). The bottom-up process, by building on the simplified and modular top-down components, can potentially help in handling challenges related to tracking and determining text associated with multiple objects and high throughput scenarios, such as complex and crowded environments.

The bottom up process therefore analyzes character positions and associations across consecutive frames over time. As the STIM 516 processes a continuous stream of image frames from sources 102, a history of recognized characters and their positions across frames is maintained. This temporal tracking may potentially help to overcome challenges related to the dynamic nature of the environment, where objects (e.g., vehicles) move, and their texts may be partially occluded or obscured in different frames.

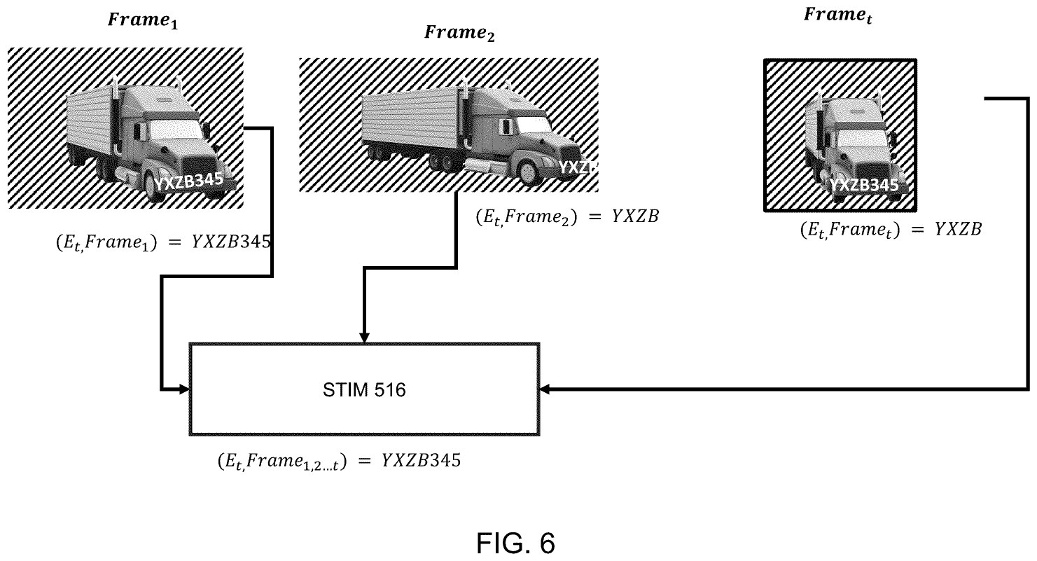

FIG. 6 is a diagram showing how the STIM 516 tracks sub-images 206 and the related simplified text sub-images 408 to assign a license plate number to a vehicle. That is, the estimated character confidence is tracked over multiple frames and smoother for a robust character recognition output.

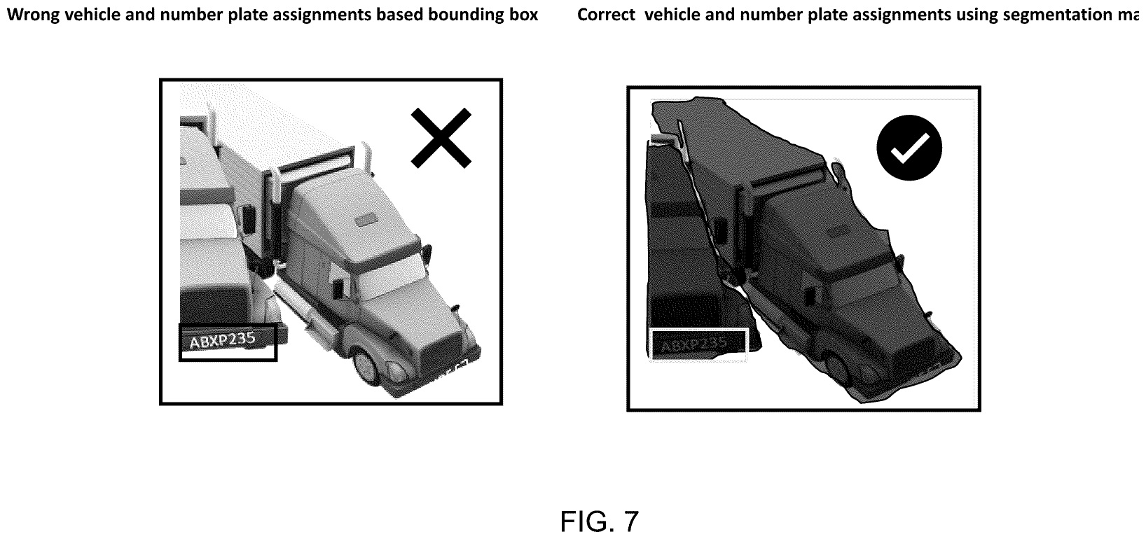

FIG. 7 is a block diagram of an aspect of the example workflow for processing images to determine text. FIG. 7 shows a comparison of how the partitioner 204 output (the correct output) is used to assign detected characters onto their corresponding objects, where the wrong images shows poor detection of the vehicle object.

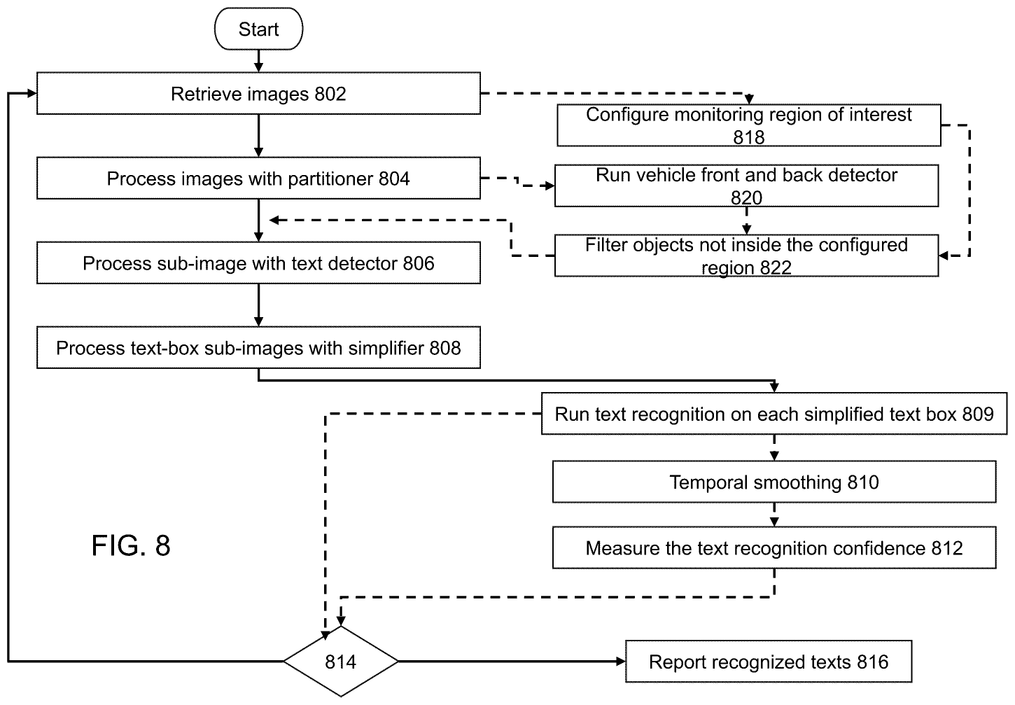

FIG. 8 is a flow diagram for a method for processing images to determine text. The description of FIG. 8 will refer to earlier figures to provide examples. It is understood that references to earlier figures is for solely for illustrative purposes, and not intended to limit the scope of the method discussed in relation to FIG. 8.

At block 802, images are retrieved from the sources 102. Retrieving can include the system pulling the images from the sources 102 or the datastore 104, or the sources 102 pushing the images to the datastore 104.

At block 804, the images from block 802 are processed with the partitioner 204 to detect a bounding box and segmentation mask of each object in the images. The bounding box is alternatively referred to as a sub-image. The partitioner 204 subdivides the image to generate the sub-image of the detected object, with the remaining partitions of the image being ignored for further processing. Each image can include multiple objects (e.g., vehicles), and different images can include different objects (e.g., different images can have different vehicles present therein).

At block 806, the text detector 302 can subdivide the sub-images into text box sub-images. Similar to block 804, the text detector 302 identifies text boxes in the sub-images with a bounding box and generates the text box sub-images based on the aforementioned bounding box.

At block 808, the text box sub-images are processed with the text box simplifier 404 to generate the simplified text box image. The simplified text box images can be binary text box images, having, for example, only black and white pixels.

At block 809, the text recognizer 410 can determine text present in the simplified text box images. The text recognizer 410 can generate a prediction of the individual characters, and the confidence in the prediction. The text recognizer 410 can be configured to output multiple predictions for each character in the simplified text box image (e.g., various character pairs, such as (O, Q), (1, I), and (2, z), and even within groups like (O, Q, D, 0)) and the associated confidence.

At 814, the output of the text recognizer can be used to determine if there is sufficiently confident predictions to report the recognized text, as shown in block 806. The confidence threshold can be varied depending on the application. For example, the confidence threshold for an automated entry/exit system for logistics can be set higher than the confidence threshold for a parking lot given the inherent security vulnerabilities associated with automated entry/exit.

Optionally, at block 810, the output of the text recognizer 410 from block 809 can be processed by a temporal smoother (e.g., STIM 516). The temporal smoother can leverage temporal relationships between characters and the associated confidence scores to which the prediction relates to in order to determine the text. The temporal smoother can be effective at eliminating noisy detections and retaining highly confident predictions. For example, the STIM 516 can determine that certain images have a higher degree of confidence and should be relied upon to a greater extent to generate the prediction of the text.

At block 812, the output text recognition confidence of the temporal smoother are measured. For example, the temporal smoother can generate an output indicative of a new prediction, and a confidence score (different than the confidence of block 809) that the new prediction is correct.

At block 814, a determination can be made as to whether the temporal smoother output satisfies a confidence threshold. The confidence threshold associated with the temporal smoother can be higher than the text recognizer 410, as the temporal smoother has access to more information.

Optionally, the method can include a monitoring process to reduce the amount of noise processed by the system to save computing resources. As shown in block 818, the system can be configured to determine the presence of an object in the region of interest of a camera source 102 (e.g., via region verification and filtering module 510). At block 820, the object edge detection module 508 can be used to determine the ends or surfaces of an object within the images that are likely to include text.

At block 822, the information from blocks 818 and 820 can be used to determine whether to process an image to determine text. For example, images where the object of interest is within a desired zone, but does not have a surface that is likely to include text can be discard or not processed. Similarly, if only a small surface that has text is present, but the object itself is unclear, the image can be discarded.

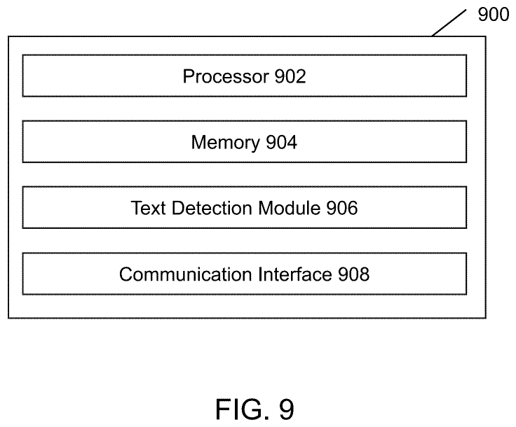

FIG. 9 shows an example device for processing images to detect text. The shown example device 900 includes a processor 902, a memory 904, a text detection module 906, and a communication interface 908.

The processor 902 can be used to execute computer executable instructions as described herein (e.g., the instructions to perform the method of FIG. 8). The processor 902 can be a plurality of processors that may be organized or distributed, and any processing function referred to herein may be carried out by one or multiple processors, even though a singular processor may be presented. Any method, application, or module described herein may be implemented using computer-readable/executable instructions that can be stored or held by such computer-readable media and executed by one or more processors.

The memory 904 can store the aforementioned computer instructions, the data within the datastores 104, 108, the text detector 906, etc. The memory 904 can be computer storage media, which term encompasses RAM, ROM, EEPROM, flash memory, or other memory technologies, CD-ROMs, digital versatile disks (DVDs), or other optical storage media, magnetic cassettes, magnetic tape, magnetic disk storage, or other magnetic storage devices, as well as any other medium suitable for storing desired information and accessible by an application, module, or both. Any such computer storage media may be part of the memory 904 or accessible/connectable to it.

The text detection module 906 can be an application, a set of computer readable instructions, etc., that performs the various text determination tasks described herein. For example, the text detection module 906 can include the partitioner 204, the text detector 302, the text box simplifier 404, and the text recognizer 410, the STIM 516, etc. The text detection module 906 can be a module solely for implementation, or it can be a module used to train the components therein.

The communication interface 908 can be used by the device 900 to communicate with various other components of the system for processing images to determine text. For example, the communications interface 908 can include a network card to communicate with a source 102 over a wireless network, or a wired network, etc. The communication interface 908 can also include input interfaces to retrieve information from a user (e.g., to annotate an image).

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the sources 102, the model 110, or any device of the text determination system described herein, or a device related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order or in parallel, or steps may be added, deleted, or modified.

Although the above principles have been described with reference to certain specific examples, various modifications thereof will be apparent to those skilled in the art as having regard to the appended claims in view of the specification as a whole.

### REFERENCES

Automatic license plate recognition system integrated in an electronic toll collection system, 1499076870413346575-US20090202105A1 (storage.googleapis.com) (US 2009/0202105 A1)
Apparatus and method for recognizing the state of origin of a vehicle license plate, 1498411299614075812-08218822 (storage.googleapis.com) (U.S. Pat. No. 8,218,822 B2)
License plate recognition with an intelligent camera 1499084869455188000-06553131 (storage.googleapis.com) (U.S. Pat. No. 6,553,131 B1)
Autonomous wide-angle license plate recognition, 1499075010874617000-08009870 (storage.googleapis.com) (U.S. Pat. No. 8,009,870 B2)
Automated vehicle recognition, US20150371109A1-Automated vehicle recognition-Google Patents (US20150371109A1)
6. Method and apparatus for receiving car parts data from an image U.S. Pat. No. 9,600,733B120170321 (storage.googleapis.com) (U.S. Pat. No. 9,600,733 B1)
7. Yolov6, Norkobil Saydirasulovich, S.; Abdusalomov, A.; Jamil, M. K.; Nasimov, R.; Kozhamzharova, D.; Cho, Y.-I. A YOLOv6-Based Improved Fire Detection Approach for Smart City Environments. Sensors 2023, 23, 3161. https://doi.org/10.3390/823063161, 2209.02976.pdf (arxiv.org)

1. A system for processing images to detect text, the system comprising:
at least one imaging device;
a processor;
a memory in communication with the imaging device, and the processor, the memory storing computer executable instructions that cause the processor to:
subdivide images received from the imaging device with a partitioner to generate one or more sub-images of respective objects in the received images;
subdivide the generated one or more sub-images with a text detector to generate, for each sub-image, one or more text box sub-images;
process the generated text box sub-images with a text box simplifier to generate simplified text box images having less information than the text box sub-images; and
determine text from the simplified text box images.

2. The system of claim 1, wherein, to determine text from the simplified text box images, the instructions cause the processor to:
with a text recognizer:
localize the simplified text box images within the respective sub-image; and
classify the simplified text box image into one of a plurality of pre-determined categories.

3. The system of claim 1, wherein the images comprise a plurality of objects, or the images comprise a plurality of images of an object.

4. The system of claim 1, wherein the simplified text box image is a binary image.

5. The system of claim 1, wherein the instructions cause the processor:
with the partitioner, assign a class to each detected object, and
wherein determining text from the simplified text box images is based on the class assigned the respective detected object.

6. The system of claim 1, wherein the instructions cause the processor:
update one of the partitioner, the text detector, or the text box simplifier; and
process a subsequent image to detect text based on the updated one of the partitioner, the text detector, or the text box simplifier.

7. The system of claim 1, wherein, determine text from the simplified text box images, the instructions cause the processor to:
process the generated simplified text box images with a text recognizer to generate predictions of the text in the simplified text box images; and
process the predictions with a temporal smoother to leverage temporal relationships between characters to which the prediction relates to in order to determine the text.

8. The system of claim 7, wherein the instructions cause the processor to:
retrieve respective one or more sub-images associated with the simplified text box images and their corresponding categorizations; and
process the predictions and the retrieved respective one or more sub-images and corresponding categorizations with the temporal smoother to leverage temporal and spatial relationships between characters to which the prediction relates to in order to determine the text.

9. The system of claim 7, wherein the temporal smoother employs a Kalman filter and temporal smoothing algorithm to process the predictions to remove low-confidence predictions.

10. The system of claim 1, wherein to determine text from the simplified text box images, the instructions cause the processor to:
process the generated simplified text box images with a text recognizer to generate predictions of the text in the simplified text box images, and
wherein the text recognizer generates a plurality of predictions for text in each of the simplified text box images.

11. The system of claim 10, wherein the text recognizer is configured with a multi-category loss function based on the plurality of predictions.

12. The system of claim 10, wherein the text recognizer is configured to perform more than one prediction of text in the generated simplified text box images to perform multi-pass hierarchical classification.

13. A method for processing images to detect text, the method comprising:
subdividing received images with a partitioner to generate one or more sub-images of respective objects in the received images;
subdividing the generated one or more sub-images with a text detector to generate, for each sub-image, one or more text box sub-images;
processing the generated text box sub-images with a text box simplifier to generate simplified text box images having less information than the text box sub-images; and
determining text from the simplified text box images.

14. The method of claim 13, wherein determining text from the simplified text box images comprises:
with a text recognizer:
localizing the simplified text box images within the respective sub-image; and
classifying the simplified text box image into one of a plurality of pre-determined categories.

15. The method of claim 13, wherein the simplified text box images are binary images.

16. The method of claim 13, comprising:
with the partitioner, assigning a class to each detected object, and
wherein determining text from the simplified text box images is based on the class assigned the respective detected object.

17. The method of claim 13, comprising:
updating one of the partitioner, the text detector, or the text box simplifier;
processing a subsequent image to detect text based on the updated one of the partitioner, the text detector, or the text box simplifier.

18. The method of claim 13, wherein determining text from the simplified text box images comprises:
processing the generated simplified text box images with a text recognizer to generate predictions of the text in the simplified text box images; and
processing the predictions with a temporal smoother to leverage temporal relationships between characters to which the prediction relates to in order to determine the text.

19. The method of claim 13, wherein determining text from the simplified text box images comprises:
processing the generated simplified text box images with a text recognizer to generate predictions of the text in the simplified text box images, and
wherein the text recognizer generates a plurality of predictions for text in each of the simplified text box images.

20. A non-transitory computer readable medium for processing images to detect text and comprising computer executable instructions, the computer executable instructions, when executed by a processor, cause the processor to:
subdivide images received from an imaging device with a partitioner to generate one or more sub-images of respective objects in the received images;
subdivide the generated one or more sub-images with a text detector to generate, for each sub-image, one or more text box sub-images;
process the generated text box sub-images with a text box simplifier to generate simplified text box images having less information than the text box sub-images; and
determine text from the simplified text box images.
